(19) United States
(12) Patent Application Publication
(10) Pub. No.: US 2022/0281268 A1
(43) Pub. Date: Sep. 8, 2022

(54) TIRE INCLUDING DISSYMMETRY SIPE

(71) Applicant: HANKOOK TIRE & TECHNOLOGY CO., LTD, Seongnam-si (KR)

(72) Inventor: Won Bin LEE, Daejeon (KR)

(21) Appl. No.: 17/687,885

(22) Filed: Mar. 7, 2022

(30) Foreign Application Priority Data
Mar. 5, 2021 (KR) 10-2021-0029356

(51) Int. Cl. B60C 11/12; B60C 11/13

(52) U.S. Cl. CPC B60C 11/1218; B60C 11/1353; B60C 2011/1213

(57) ABSTRACT

Propose is a tire including dissymmetric sipes of which vertical positions of channels are different from each other, the tire including a base tread part positioned on an edge of the tire to include a portion having a ring shape; a plurality of tread block parts formed on an outer surface of the base tread part; a groove part formed between the tread block parts; and a sipe part formed in at least one of the tread block parts, wherein the sipe part includes a rift part including a gap of the tread block part and a channel part connected to the rift part to have a greater width than the rift part, and vertical positions of the channel parts in at least two of the sipe parts may be different from each other.

### CROSS REFERENCE TO RELATED APPLICATION

The present application claims priority to Korean Patent Application No. 10-2021-0029356, filed on Mar. 5, 2021, the entire contents of which is incorporated herein for all purposes by this reference.

### BACKGROUND OF THE INVENTION

### Field of the Invention

The present invention relates to a tire including dissymmetric sipes.

More particularly, the present invention relates to a tire including dissymmetric sipes of which vertical positions of channels are different from each other.

### Description of the Related Art

In general, a tire may include a tread which is a part that makes contact with a road surface when a vehicle drives.

Such a tread may be provided with a sipe including a groove for improving braking force, driving force, traction force, anti-slip, and the like.

As for a conventional technology on a tire including a sipe, Korean Patent Publication No. 10-0869025 [Patent Document 1] discloses a technical configuration, in which the width of the sipe varies according to the depth thereof.

However, in the technique according to Patent Document 1, when the tire tread wears down as the travel distance increases, a step difference may be generated due to the difference in the amount of wear of the leading part and the trailing part of the tire.

The generation of the step difference in the tread may lead to vibrations and noise in the vehicle and the deterioration in the wear performance.

As for another conventional technology on a tire including a sipe, Korean Patent Publication No. 10-2011-0056792 [Patent Document 2] discloses a technical configuration in which a spiral portion is formed on an inner wall surface of a channel of a sipe.

However, in the technique according to Patent Document 2, when the tire tread wears down as the travel distance increases, a step difference may also be generated due to the difference in the amount of wear of the leading part and the trailing part of the tire.

### DOCUMENTS OF RELATED ART

(Patent Document 1) Korean Patent No. 10-0869025

(Patent Document 2) Korean Patent No. 10-2011-0056792

### SUMMARY

An object of the present invention is to provide a tire including dissymmetric sipes configured to prevent the generation of a step difference even when a tread wears down.

The tire including dissymmetric sipes according to the present invention may include a base tread part positioned on an edge of the tire to include a portion having a ring shape, a plurality of tread block parts formed on an outer surface of the base tread parts, a groove part formed between the tread block parts, and a sipe part formed in at least one of the tread block parts, wherein the sipe part includes a rift part including a gap in the tread block part and a channel part connected to the rift part to have a greater width than the rift part, and vertical positions of the channel parts in at least two of the sipe parts may be different from each other.

Further, the sipe part may include a first sipe part and a second sipe part adjacent to each other, wherein the first sipe part may include a first rift part extending from a surface of the tread block part and a first channel part connected to the first rift part and positioned under the first rift part, and the second sipe part may include a 2-1 rift part extending from the surface of the tread block part, a second channel part connected to the 2-1 rift part and positioned under the 2-1 rift part, and a 2-2 rift part connected to the second channel part and positioned under the second channel part.

Further, the first rift part may overlap the 2-1 rift part and the second channel part in the horizontal direction of the tread block part, and the first channel part may overlap the 2-2 rift part in the horizontal direction of the tread part.

Further, the total depth (height) of the first sipe part and the second sipe part may be approximately the same.

Further, the second channel part may include a first diminishing portion including a portion in which the width of the second channel part gradually diminishes toward the 2-1 rift part in the boundary portion between the second channel part and the 2-1 rift part, a second diminishing portion including a portion in the width of the second channel part gradually diminishes toward the 2-2 rift part in the boundary portion between the second channel part and the 2-2 rift part, and a first maintenance portion positioned between the first diminishing portion and the second diminishing portion to include a portion of which the width is maintained constant.

Further, the sipe part may further include a third sipe part adjacent to either of the first sipe part and the second sipe part, and the third sipe part may include a third channel part extending from the surface of the tread block part and a third rift part connected to the third channel part and positioned under the third channel part.

Further, the third channel part may overlap the first rift part and the 2-1 rift part in the horizontal direction of the tread block part and the third rift part may overlap the first channel part, the first rift part, the second channel part, and the 2-2 rift part in the horizontal direction of the tread block part.

Here, the second channel part may not overlap the third channel part in the horizontal direction.

Further, the total depth (height) of the first sipe part, the second sipe part, and the third sipe part may be approximately the same.

Further, the third channel part may include a third diminishing portion including a portion in which the third channel part has a diminishing width toward the third rift part at a boundary portion between the third channel part and the third rift part and a second maintenance portion positioned between the third diminishing portion and the surface of the tread block part to include a portion of which the width is maintained constant.

The tire including dissymmetric sipes according to the present invention has the effect of checking and/or preventing the generation of a step difference even when the tread wears down.

The tire including the dissymmetric sipes according to the present invention has an effect of improving wet and traction performance.

The tire including the dissymmetric sipes according to the present invention has the effect of reducing the vibrations and noise in the vehicle and checking and/or preventing the deterioration of wear performance.

### BRIEF DESCRIPTION OF THE DRAWINGS

FIGS. 1 and 2 are views for describing a configuration of a tire including dissymmetric sipes according to the present invention.

FIGS. 3 to 6 are views for describing a block part and a sipe part.

FIGS. 7 to 11 are views for describing a first embodiment of a dissymmetric sipe part.

FIGS. 12 to 16 are views for describing a second embodiment of the dissymmetric sipe part.

FIGS. 17 to 19 are views for describing a third embodiment of the dissymmetric sipe part.

### DETAILED DESCRIPTION OF THE INVENTION

A tire including dissymmetric sipes according to the present invention will be described in detail with reference to the accompanying drawings in the following.

The present invention may be subject to various modifications and have various embodiments, and specific embodiments will be illustrated in the drawings and described in detail in the detailed description. It is to be understood that this is not intended to limit the present invention to the specific embodiments and that all modifications, equivalents, and substitutes within the spirit and scope of the present invention are included.

In describing the present invention, terms such as first, second, etc. may be used to describe various components, but the components may not be limited by the terms. The terms may only be used for the purpose of distinguishing one component from another. For example, without departing from the scope of the present invention, a first component may be denoted as a second component, and similarly, a second component may also be denoted as a first component.

The term “and/or” may include a combination of a plurality of related items listed or any of the plurality of related items listed.

When a component is referred to as being “connected” or “coupled” to another component, the component may be directly connected or coupled to the another component, but it is to be understood that other components may exist in between. On the other hand, when a component is referred to as being “directly connected” or “directly coupled” to another component, it is to be understood that there are no intervening components present.

The terms used herein are used for the purpose of describing specific embodiments only and are not intended to limit the invention. Singular expressions may include plural expressions unless the context explicitly indicates otherwise.

In the present document, terms such as “comprise” or “have” are intended to point out the presence of features, numbers, steps, operations, components, parts, or combinations thereof disclosed in the specification, and it is to be understood that the presence or additional possibilities of one or more of other features, numbers, steps, operations, components, parts or combinations thereof are not precluded in advance.

Unless otherwise defined, all terms used herein, including technical or scientific terms, may have the same meanings as are generally understood by those skilled in the art to which the present invention pertains. The terms such as those defined in commonly used dictionaries may be interpreted as having meanings consistent with their meanings in the context of the related technology and may not be interpreted in an idealized or overly formal sense unless expressly so defined herein.

In addition, the embodiments disclosed in the present document are provided for a better description to those skilled in the art, and the shapes and sizes of the elements in the drawings may be exaggerated for a clearer description.

In describing the present invention, the present document may omit the detailed description when it is determined that a specific description of a related well-known function or configuration may unnecessarily obscure the point of the present invention.

In the following, a first direction DR1 may be a direction along the width (breadth) of the block part of the tread part. The first direction DR1 may be referred to as a breadth direction or width direction.

A second direction DR2 may be a direction along the length (longitude) of the block part of the tread part. The second direction DR2 may be referred to as a longitudinal direction or length direction.

A third direction DR3 may be a direction along the height (depth) of the block part of the tread part. The third direction DR3 may be referred to as a vertical direction or depth direction.

The first direction DR1 may (perpendicularly) cross the second direction DR2 and the third direction DR3, and the second direction DR2 may (perpendicularly) cross the third direction DR3.

The first direction DR1 and the second direction DR2 may be collectively referred to as the horizontal direction DRH.

The third direction DR3 may be referred to as the vertical direction DRV.

The circular direction DRC may (perpendicularly) crosses the axle and mean an extending direction along an edge of the tread surface.

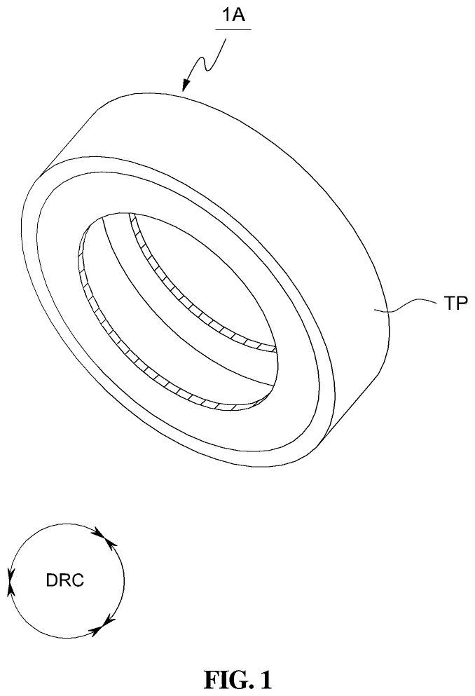

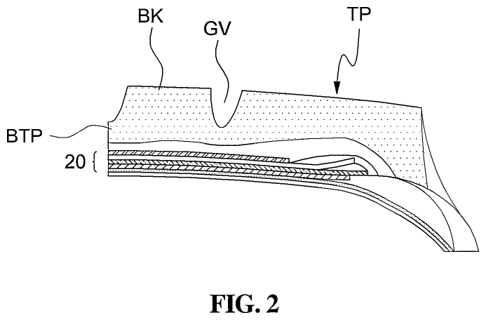

FIGS. 1 and 2 are views for describing a configuration of a tire including dissymmetric sipes according to the present invention.

FIGS. 1 and 2 show that a tire 1A (hereinafter, possibly referred to as a ‘tire’) including dissymmetric sipes according to the present invention may include a tread part TP including a portion making contact with a road surface.

The tread part TP may include a rubber composition having excellent wear resistance to cope with friction with the road surface.

The tire 1A in the present invention may be of any type as long as the tire includes the tread part TP. For example, the tire 1A may be of any type such as a pneumatic tire, a heavy-load pneumatic tire, or a non-pneumatic tire under the condition that the tire includes the tread part TP.

Considering that the block part BK is often applied to the tread part TP of the heavy-load pneumatic tire applied to medium-to-large vehicles such as buses, trucks, and the like, it may be preferable for the tire 1A in the present invention to be a heavy-load tire.

FIG. 2 shows that the tread part TP may include a base tread part BTP, a tread block part BK (hereinafter, possibly referred to as ‘block part’), a groove part GV, and a sipe part (not illustrated).

The base tread part BTP may include a portion positioned on the edge of the tire 1A in the circular direction DRC to have a ring shape.

The block part BK may be formed on an outer surface of the base tread part BTP.

In addition, the base tread part BTP may include a plurality of block parts BK.

The base tread part BTP and the tread block part BK may be integrally formed.

The groove part GV may be formed between the tread block parts BK.

The groove part GV may be formed in various patterns.

Forming such a groove part GV may improve the wet performance of the tire 1A.

The reference numeral 20, not described, in FIG. 2 may be a belt part including at least one belt layer.

The belt part 20 may improve the structural stability of the tire 1A.

Although not illustrated, the sipe part may be formed in at least one block part BK. The sipe part will be described in detail below with reference to the accompanying drawings.

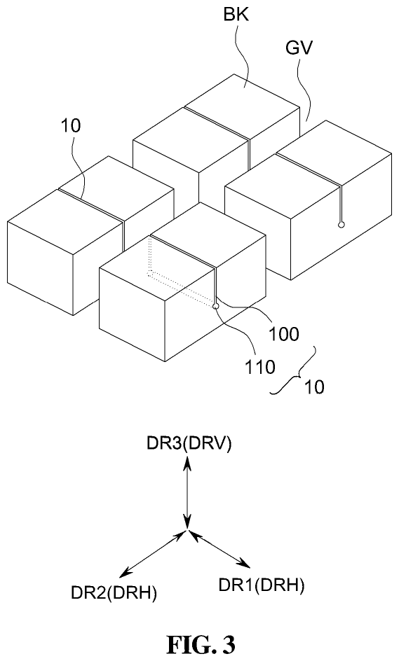

FIGS. 3 to 6 are views for describing the block part and the sipe part. The description of the portions described in detail above may be omitted in the following.

FIG. 3 shows that the sipe part 10 may be formed in the block part BK.

The sipe part 10 may include a rift part 100 and a channel part 110.

The sipe part 10 may also be referred to as a kerf part. The ‘sipe’ may have the same meaning as the ‘kerf’ in the present invention.

The rift part 100 may include a gap in the tread block part BK.

The channel part 110 may be formed inside the tread block part BK and be connected to the rift part 100.

The rift part 100 may extend from the surface of the tread block part BK to the channel part 110.

In addition, the width of the channel part 110 may be greater than the width of the rift part 100.

Here, the ‘width’ may refer to the width of the block BK in the horizontal direction DRH (the first direction DR1 or the second direction DR2).

FIG. 3 exemplifies the cross-section of the block part BK being rectangular in the horizontal direction DRH (the first direction DR1 or the second direction DR2), but the present invention is not limited thereto.

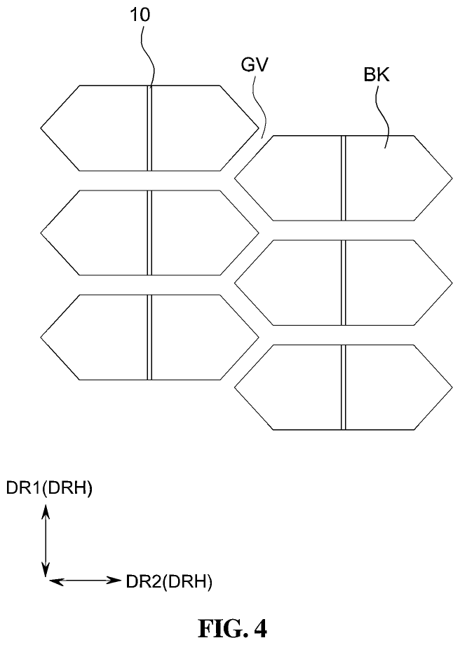

For example, as illustrated in FIG. 4, the cross-section of the block part BK may be hexagonal in the horizon direction DRH.

As described above, the shape of the block part BK may be variously modified in the present invention.

On the other hand, the formation direction of the sipe part 10 may be variously modified in the present invention.

For example, as illustrated in FIG. 3, the sipe part may be formed in the first direction DR1, that is, the width direction or breadth direction of the block part BK, among the horizontal directions DRH in the block part BK.

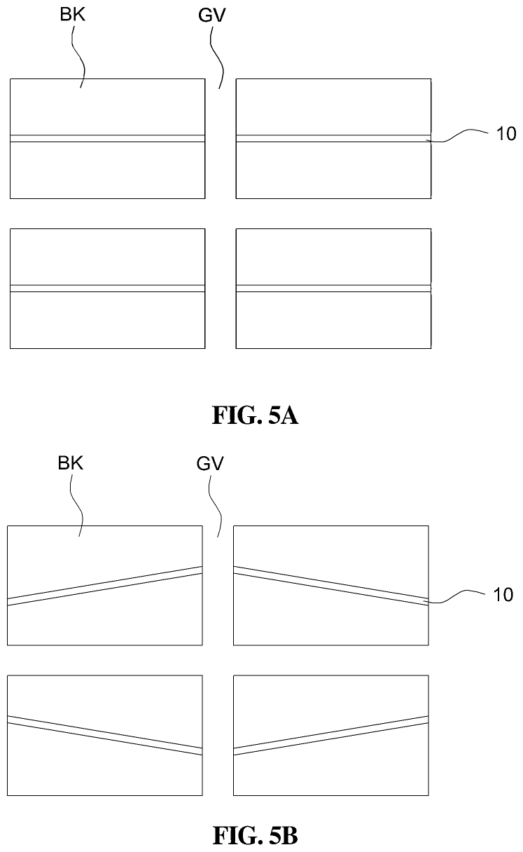

Alternatively, as illustrated in FIG. 5A, the sipe part may be formed in the second direction DR2, that is, the length direction or longitudinal direction of the block part BK, among the horizontal directions DRH in the block part BK.

Alternatively, as illustrated in FIG. 5B, the sipe part may be formed in an oblique direction in the block part BK.

On the other hand, the shape of the sipe part 10 may be variously modified in the block part BK in the present invention.

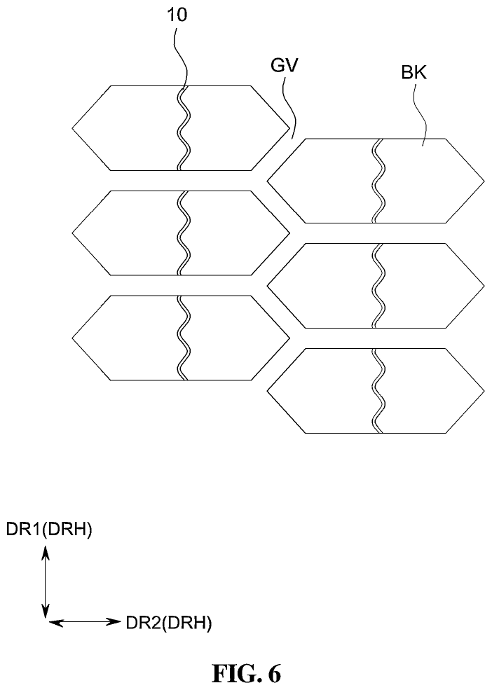

For example, as illustrated in FIG. 6, the sipe part 10 may have a zigzag shape similar to a spiral shape.

The sipe part 10 may be of a dissymmetric type in the present invention, as is described below with reference to the accompanying drawings.

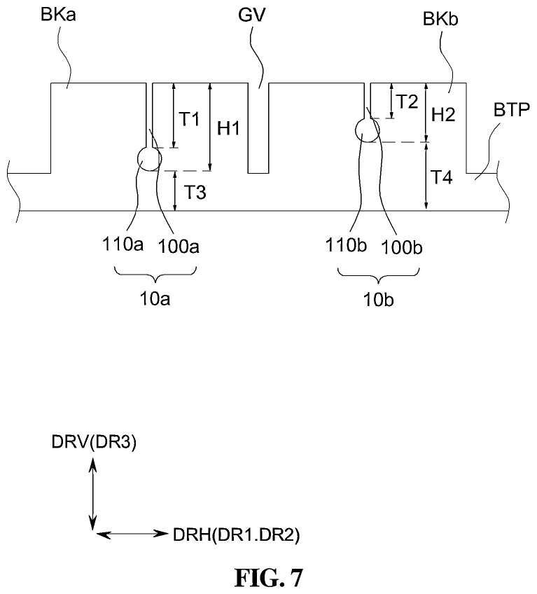

FIGS. 7 to 11 are views for describing a first embodiment of a dissymmetric sipe part. The description of the portion described in detail above may be omitted in the following.

The vertical positions of the channel parts 110 of at least two sipe parts 10 may be different from each other in the tire 1A according to the present invention.

For example, as illustrated in FIG. 7, the vertical position of a first channel part 110a of a first sipe part 10a formed in a first block part BKa and the vertical position of a second channel part 110b of a second sipe part 10b formed in a second block part BKb may be different from each other.

The first sipe part 10a may include a first rift part 100a and the first channel part 110a.

The first rift part 100a may extend from the surface of the first block part BKa.

The first channel part 110a may be positioned under the first rift part 100a and be connected to the first rift part 100a.

The width W2 of the first channel part 110a of the first sipe part 10a is greater than the width W1 of the first rift part 100a.

The second sipe part 10b may include a second rift part 100b and the second channel part 110b.

The second rift part 100a may extend from the surface of the second block part BKb.

The second channel part 110b may be positioned under the second rift part 100b and be connected to the second rift part 100b.

The width of the second channel part 110b of the second sipe part 10b may be greater than the width of the second rift part 100b.

The length T1 (height) of the first rift part 100a in the vertical direction DRV (the third direction DR3) in the first sipe part 10a may be different from the length T2 (height) of the second rift part 100b in the vertical direction DRV in the second sipe part 10b. For example, the length T1 of the first rift part 100a in the vertical direction DRV in the first sipe part 10a may be greater than the length T2 of the second rift part 100b in the vertical direction DRV in the second sipe part 10b.

Accordingly, the vertical position of the first channel part 110a connected to the end of the first rift part 100a of the first sipe part 10a and the vertical position of the second channel part 110b connected to the end of the second rift part 100b of the second sipe part 10b may be different from each other.

More specifically, the vertical position of the first channel part 110a of the first sipe part 10a from the surface of the first block part BKa and the vertical position of the second channel part 110b of the second sipe part 10b from the surface of the second block part BKb may be different from each other.

On the other hand, the vertical position of the first channel part 110a and the vertical position of the second channel part 110b, viewed from the base tread part BTP, may be different from each other.

For example, the first channel part 110a of the first sipe part 10a may be spaced apart from the base tread part BTP by T3 and the second channel part 110b of the second sipe part 10b may be spaced apart from the base tread part BTP by T4.

From another point of view, the vertical position of the first channel part 110a of the first sipe part 10a from the base tread part BTP and the vertical position of the second channel part 110b of the second sipe part 10b from the base tread part BTP may be different from each other.

In this case, the total depth H1, that is, the length H1 in the vertical direction DRV, of the first sipe part 10A may be greater than the total depth H2, that is, the length H2 in the vertical direction DRV, of the second sipe part 10b.

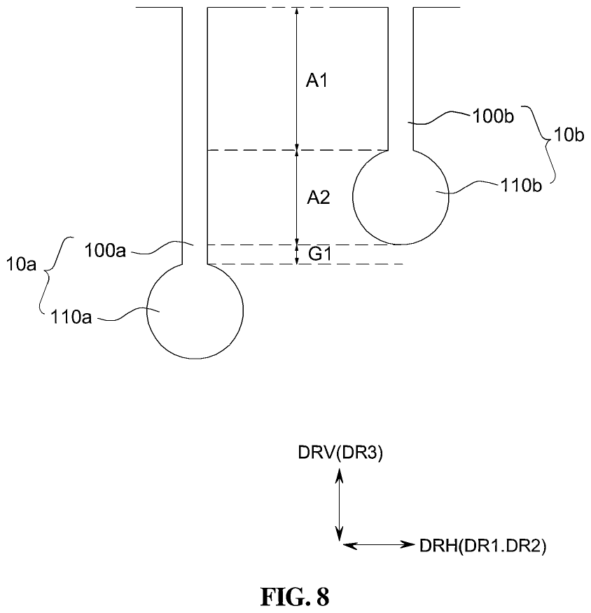

A more detailed comparison between the first sipe part 10a and the second sipe part 10b shows that, as illustrated in FIG. 8, the firsts rift part 100a and the second rift part 100b may overlap each other in the horizontal direction DRH in a region A1.

The region A1 may be adjacent to the surface of the block part BK.

The first rift part 100a and the second channel part 110b may overlap each other in a region A2 positioned under the region A1 with respect to the surface of the block part BK.

In this case, the first channel part 110a and the second channel part 110b may be spaced apart from each other by a predetermined distance in the vertical direction DRV. That is, the first channel part 110a and the second channel part 110b may not overlap each other in the vertical direction DRV.

When the vertical positions of the channel part 110 are different from each other in at least two sipe parts 10 as described above, the generation of a step difference may be prevented or checked even when the block part BK wears down.

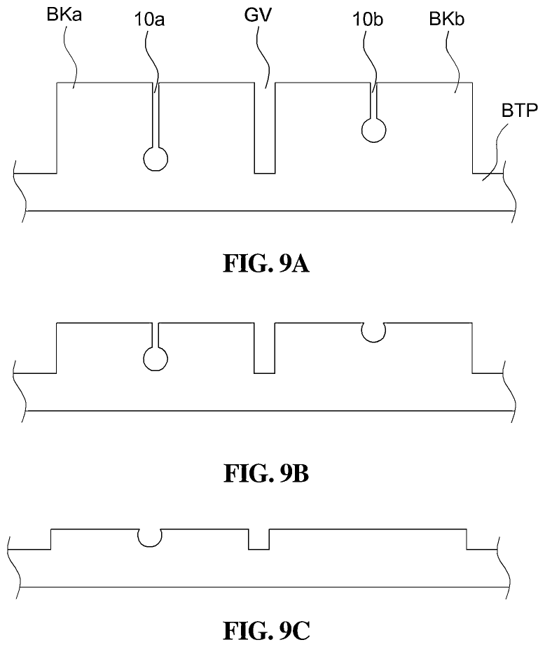

For example, as illustrated in FIG. 9A, the first rift part 100a and the second rift part 100b may be exposed on the surfaces of the first block part BKa and the second block part BKb during the initial use period of the tire 1A.

Thereafter, when the use period of the tire 1A increases and the tread part TP wears down, as illustrated in FIG. 9B, the first rift part 100a is exposed in the first block part BKa and the second channel part 110b may be exposed in the second block part BKb. In this case, the tire 1A may be in the middle use period.

Thereafter, when the use period of the tire 1A further increases and the tread part TP further wears down, as illustrated in FIG. 9C, the first channel part 110a may be exposed in the first block part BKa. In this case, the tire 1A may be in the terminal use period.

At least two block parts BK may show different patterns depending on the degree of wear of the tread part TP, as described above.

Accordingly, fixation of wear patterns of the block parts BK may be checked or prevented, thereby checking or preventing the generation of step difference in the tread parts TP.

Unlike the present invention, it may be assumed that the first sipe 10a formed in the first block part BKa and the second sipe 10b formed in the second block part BKb are the same.

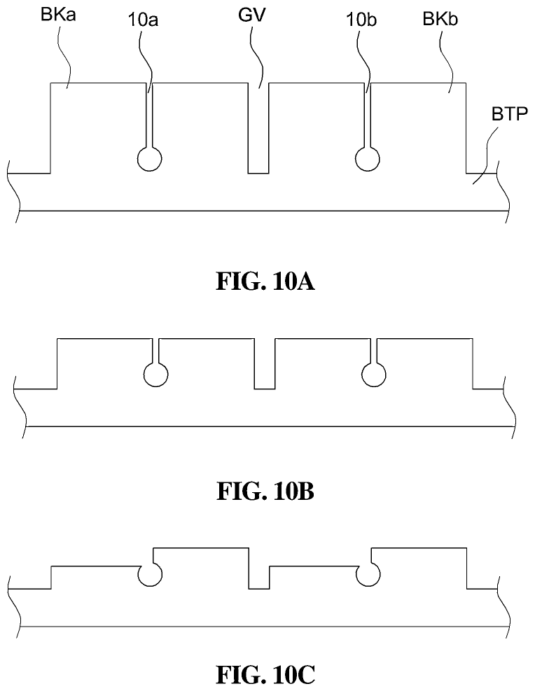

In this case, as illustrated in FIGS. 10A, 10B, and 10C, the surfaces of the first block part BKa and the second block part BKb may be similar or the same in the initial A, middle B, and terminal C use periods of the tire 1A.

Accordingly, the wear pattern of the tread part TP may be fixed in the initial A, middle B, and terminal C use periods of the tire 1A, thereby further aggravating wear in certain portions of the tread part TP relatively and slowing down wear in other portions relatively.

Accordingly, a step difference may be generated in the tread part TP.

FIG. 10C illustrates an example of the step difference generated in the tread part TP.

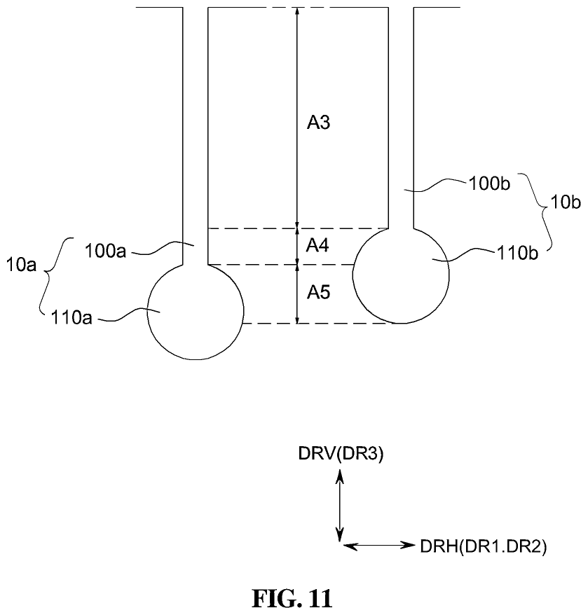

FIG. 11 shows that the first channel part 110a of the first sipe part 10a and the second channel part 110b of the second sipe part 10b may overlap each other in the vertical direction DRV.

For example, the first rift part 100a and the second rift part 100b may overlap each other in the horizontal direction DRH in a region A3.

The region A3 may be adjacent to the surface of the block part BK.

The first rift part 100a and the second channel part 110b may overlap each other in a region A4 positioned under the region A3 with respect to the surface of the block part BK.

The first channel part 110a and the second channel part 110b may overlap each other in a region A5 positioned under the region A4 with respect to the surface of the block part BK.

In this case, fixation of the wear pattern of the tread part TP may be checked or prevented, thereby checking or preventing the generation of step difference caused by wear of the tread part TP.

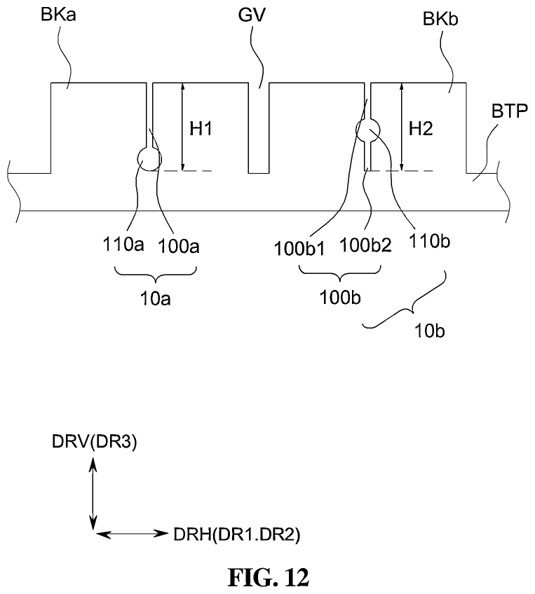

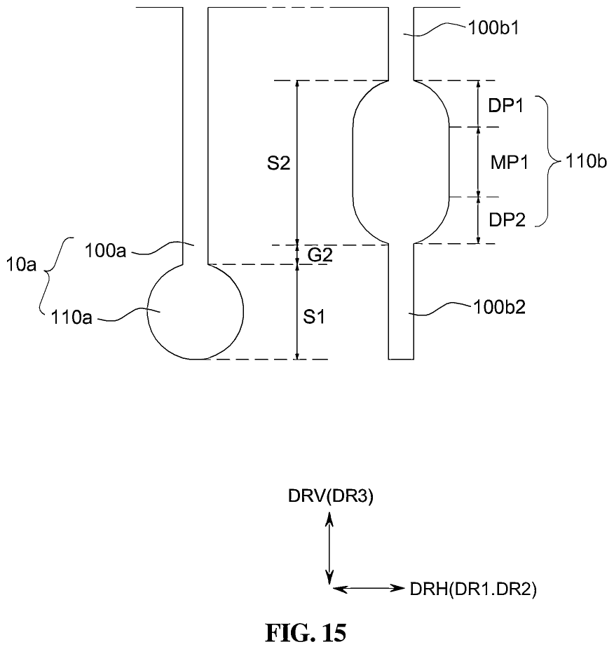

FIGS. 12 to 16 are views for describing a second embodiment of the dissymmetric sipe parts. The description of portions described in detail above may be omitted in the following.

FIG. 12 shows that the second sipe part 10b may include a 2-1 rift part 100b1, a second channel part 110b, and a 2-2 rift part 100b2.

Comparison of FIG. 12 with FIG. 7 shows that the second sipe part 10b may further include another rift part.

The 2-1 rift part 100b1 may be adjacent to the surface of the second block part BKb and extend to the surface of the second block part BKb.

The second channel part 110b may be positioned under the 2-1 rift part 100b1, and the second channel part 110b may be connected to a lower portion of the 2-1 rift part 100b1.

The 2-2 rift part 100b2 may be positioned under the second channel part 110b, and the 2-2 rift part 100b2 may be connected to a lower portion of the second channel part 110b.

The second channel part 110b may be positioned between the 2-1 rift part 100b1 and the 2-2 rift part 100b2.

In this case, the vertical position of the first channel part 110a of the first sipe part 10a and the vertical position of the second channel part 110b of the second sipe part 10b may be different from each other.

In addition, the total depth H1, that is, the length H1 in the vertical direction DRV, of the first sipe part 10a may be substantially the same as the total depth H2, that is, the length H2 in the vertical direction DRV, of the second sipe part 10b.

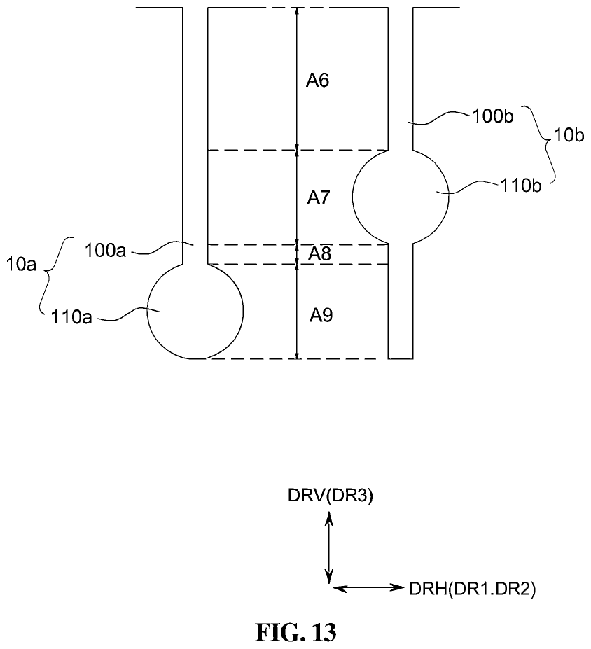

FIG. 13 shows that the first rift part 100a and the 2-1 rift part 100b1 may overlap each other in the horizontal direction DRH in a region A6 adjacent to the surface of the block part BK.

The first rift part 100a and the second channel part 110b may overlap each other in a region A7 positioned under the region A6 with respect to the surface of the block part BK.

The first rift part 100a and the 2-2 rift part 100b2 may overlap each other in a region A8 positioned under the region A7 with respect to the surface of the black part BK.

The first channel part 110a and the 2-2 rift part 100b2 may overlap each other in a region A9 positioned under the region A8 with respect to the surface of the block part BK.

FIG. 13 shows that the first channel part 110a of the first sipe part 10a and the second channel part 110b of the second sipe part 10b may overlap each other in the vertical direction DRV.

In this case, the generation of the step difference may be checked or prevented even when the block part BK wears down.

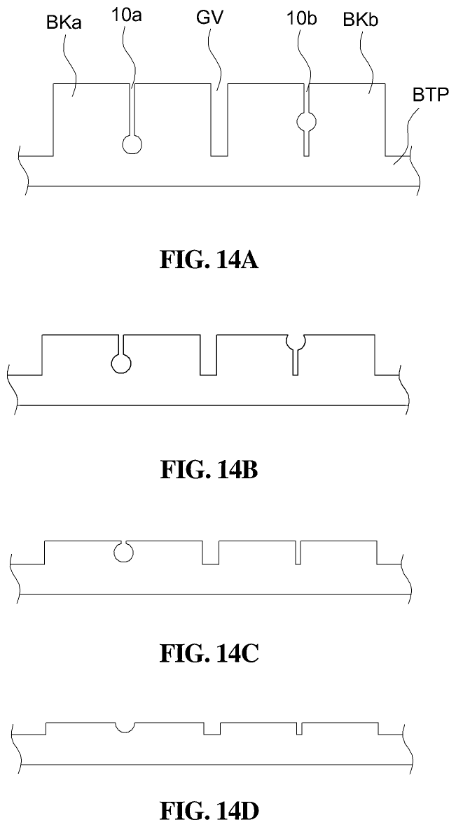

For example, as illustrated in FIG. 14A, the first rift part 100a and the 2-1 rift part 100b1 may be exposed on the surfaces of the first block part BKa and the second block part BKb in the initial use period of the tire 1A.

Thereafter, when the use period of the tire 1A increases and the tread part TP wears down, as illustrated in FIG. 14B, the first rift part 100a may be exposed in the first block part BKa and the second channel part 110b may be exposed in the second block part BKb. In this case, the tire 1A may be in a first middle use period.

Thereafter, when the tread part TP further wears down, as illustrated in FIG. 14C, the first rift part 100a may be exposed in the first block part BKa and the 2-2 rift part 100b2 may be exposed in the second block part BKb. In this case, the tire 1A may be in a second middle use period.

Thereafter, when the tread part TP further wears down, as illustrated in FIG. 14D, the first channel part 110a may be exposed in the first block part BKa and the 2-2 rift part 100b2 may be exposed in the second block part BKb. In this case, the tire 1A may be in the terminal use period.

At least two block parts BK may have different patterns depending on the degree of wear of the tread part TP as described above, thereby checking or preventing the generation of step difference in the tread part TP.

On the other hand, the first channel part 110a of the first sipe part 10a and the second channel part 110b of the second sipe part 10b may have different shapes.

For example, the cross-section of the first channel part 110a in the vertical direction DRV may have a circular shape, and the cross-section of the second channel part 110b in the vertical direction DRV may have a shape similar to an ellipse.

In this case, the height S2 of the second channel part 110b in the vertical direction DRV may be greater than the height S1 of the first channel part 110a.

However, the present invention is not limited thereto, and the height S2 of the second channel part 110b may be less than or equal to the height S1 of the first channel part 110a by design.

In addition, the first channel part 110a and the second channel part 110b may be spaced apart from each other by a predetermined distance G2 and may overlap each other depending on the design.

A more detailed look at the shape of the second channel part 110b shows that the second channel part 110b may include a first diminishing portion DP1, a second diminishing portion DP2, and a first maintenance portion MP1.

Here, the first diminishing portion DP1 may include a portion of which the width gradually diminishes toward the 2-1 rift part 100b1 in the boundary portion between the second channel part 110b and the 2-1 rift part 100b1.

The second diminishing portion DP2 may include a portion of which the width gradually diminishes toward the 2-2 rift part 100b2 in the boundary portion between the second channel part 110b and the 2-2 rift part 100b2.

The first maintenance portion MP1 may be positioned between the first diminishing portion DP1 and the second diminishing portion DP2 and have a portion of which the width is maintained constant.

As described above, when the length S2 (height) of the second channel part 110b in the vertical direction DRV is greater than the length S1 (height) of the first channel part 110a, the generation of step difference of the tread part TP may be further checked or prevented in the middle use period, which is relatively longer than the initial or terminal use period, of the tire 1A.

On the other hand, the formation of the first sipe part 10a and the second sipe part 10b in block parts BKa and BKb, different from each other, is described above, but the first sipe part 10a and the second sipe part 10b may be formed together in one block part BK.

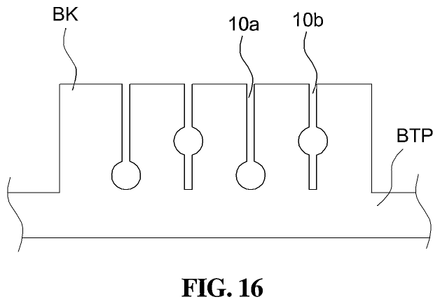

For example, as illustrated in FIG. 16, two first sipe part 10a and two second sipe part 10b may be formed and be alternately disposed in one block part BK.

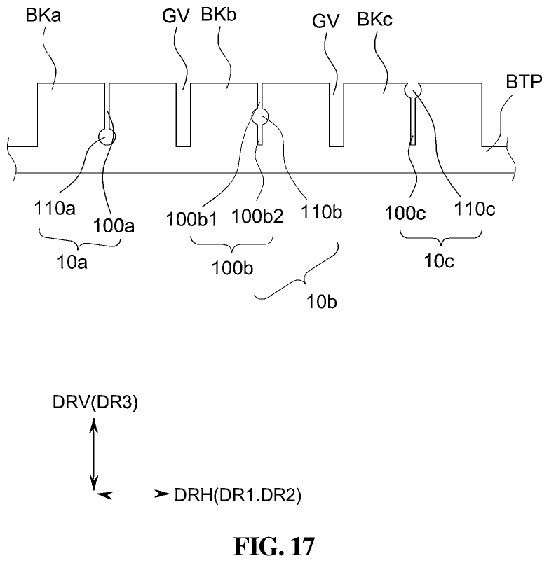

FIGS. 17 to 19 are views for describing a third embodiment of the dissymmetric sipe parts. Description of the portions described in detail above may be omitted in the following.

FIG. 17 shows that the tire 1A according to the present invention may further include a third block part BKc in which a third sipe part 10c is formed.

The third sipe part 10c may include a third channel part 110c and a third rift part 100c.

The third channel part 110c may be adjacent to the surface of the third block part BKc and extend to the surface of the third block part BKc.

The third rift part 100c may be positioned under the third channel part 110c and be connected to a lower portion of the third channel part 110c.

In this case, the vertical position of the first channel part 110a of the first sipe part 10a and the vertical positions of the second channel part 110b of the second sipe part 10b and the third channel part 110c of the third sipe part 10c may be different from each other.

The total depth, that is, the length in the vertical direction DRV, of the first sipe part 10a may be substantially the same as the total depth of the second sipe part 10b and the total depth of the third sipe part 10c.

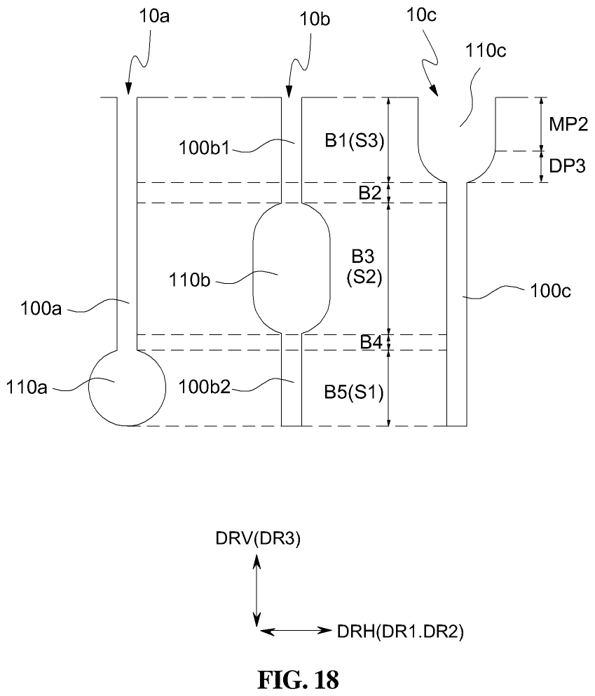

FIG. 18 shows that the first rift part 100a, the 2-1 rift part 100b1, and the third channel part 110c may overlap each other in the horizontal direction DRH in a region B1 adjacent to the surface of the block part BK.

The firsts rift part 100a, the 2-1 rift part 100b1, and the third rift part 100c may overlap each other in a region B2 positioned under the region B1 with respect to the surface of the block part BK. Further, the third channel 110c and the second channel part 110b may overlap each other.

The first rift part 100a, the second channel part 110b, and the third rift part 100c may overlap each other in a region B3 positioned under the region B2 with respect to the surface of the block part BK.

The first rift part 100a, the 2-2 rift part 100b2, and the third rift part 100c may overlap each other in a region B4 positioned under the region B3 with respect to the surface of the block part BK. Further, the first channel part 110a and the second channel part 110b may overlap each other.

The first channel part 110a, the 2-2 rift part 100b2, and the third rift part 100c may overlap each other in a region B5 positioned under the region B4 with respect to the surface of the block part BK.

In this case, the length in the vertical direction, that is, the height S2, of the second channel part 110b may be greater than the length S1 of the first channel part 110a in the vertical direction. However, the present invention is not limited thereto, and the height S2 of the second channel part 110b may be less than or equal to the length S1 of the first channel part 110a.

In addition, the length S3 of the third channel part 110c in the vertical direction may be less than or equal to the length S2 of the second channel part 110b in the vertical direction.

The first channel part 110a of the first sipe part 10a, the second channel part 110b of the second sipe part 10b, and the third channel part 110c of the third sipe part 10c may have shapes different from each other.

A more detailed look at the shape of the third channel part 110c shows that the third channel part 110c may include a second maintenance portion MP2 and a third diminishing portion DP3.

Here, the third diminishing portion DP3 may include a portion of which the width gradually diminishes toward the third rift portion 100c in the boundary portion between the third channel part 110c and the third rift part 100c.

The third maintenance portion MP3 may be positioned between the third diminishing portion DP3 and the surface of the third block part BKc and include a portion of which the width is maintained constant.

In this case, the generation of step difference may be prevented or checked even when the block part BK wears down.

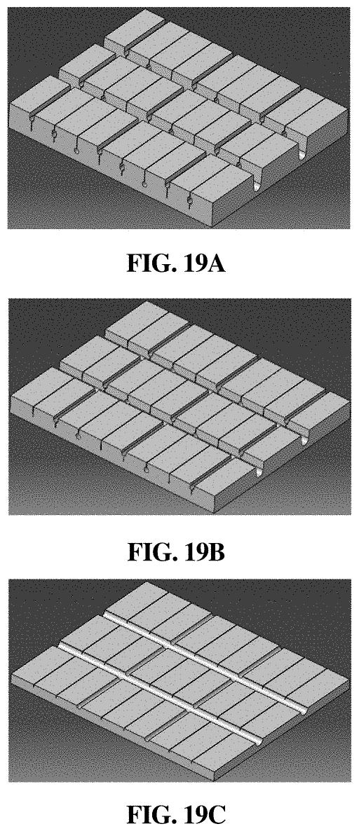

For example, as illustrated in FIGS. 19A, 19B, and 19C, the first block part BKa, the second block part BKb, and the third block part BKc may have wear patterns different from each other in the initial, middle, and terminal use periods of the tire 1A.

Accordingly, the generation of step difference in the tread part TP may be checked or prevented.

It may be understood that the technical configuration of the present invention may be implemented in a specific form without modifications of the technical spirit or essential features of the present invention by those skilled in the art to which the present invention pertains.

Therefore, it is to be understood that the embodiments described above are illustrative and not restrictive in all aspects, and the scope of the present invention is to be interpreted as being represented by the claims described below rather than the detailed description above and the significance and scope of the claims and all modifications and altered forms derived from the equivalent concepts are to be interpreted as being included in the scope of the present invention.

What is claimed is:

1. A tire including dissymmetric sipes, comprising:
a base tread part positioned on an edge of the tire to include a portion having a ring shape;
a plurality of tread block parts formed on an outer surface of the base tread part;
a groove part formed between the tread block parts; and
a sipe part formed in at least one of the tread block parts, wherein the sipe part includes:
a rift part including a gap in the tread block part, and
a channel part connected to the rift part to have a greater width than the rift part, and wherein vertical positions of the channel parts in at least two of the sipe parts are different from each other.

2. The tire of claim 1, wherein the sipe part includes a first sipe part and second sipe part which are placed adjacent to each other,
wherein the first sipe part includes:
a first rift part extending from a surface of the tread block part; and
a first channel part connected to the first rift part and positioned under the first part, and
wherein the second sipe part includes:
a 2-1 rift part extending from the surface of the tread block part;
a second channel part connected to the 2-1 rift part and positioned under the 2-1 rift part; and
a 2-2 rift part connected to the second channel part and positioned under the second channel part.

3. The tire of claim 2, wherein
the first rift part overlaps the 2-1 rift part and the second channel part in the horizontal direction (DRH) of the tread block part, and
the first channel part overlaps the 2-2 rift part in the horizontal direction (DRH) of the tread block part.

4. The tire of claim 3, wherein the second channel part includes:
a first diminishing portion including a portion in which width of the second channel part gradually diminishes toward the 2-1 rift part in a boundary portion between the second channel part and the 2-1 rift part;
a second diminishing portion including a portion in which the width of the second channel part gradually diminishes toward the 2-2 rift part in a boundary portion between the second channel part and the 2-2 rift part; and
a first maintenance portion, which is positioned between the first diminishing portion and the second diminishing portion, including a portion of which the width is maintained constant.

5. The tire of claim 2, wherein
the sipe part further includes a third sipe part adjacent to either one of the first sipe part and the second sipe part, and
wherein the third sipe part includes:
a third channel part extending from the surface of the tread block part; and
a third rift part connected to the third channel part and positioned under the third channel part.

6. The tire of claim 5, wherein
the third channel part overlaps the first rift part and the 2-1 rift part in the horizontal direction (DRH) of the tread block part, and
the third rift part overlaps the first channel part, the first rift part, the second channel part, and the 2-2 rift part in the horizontal direction (DRH) of the tread block part.

7. The tire of claim 5, wherein the third channel part includes:
a third diminishing portion including a portion in which width of the third channel part gradually diminishes toward the third rift part in a boundary portion between the third channel part and the third rift part; and
a second maintenance portion, which is positioned between the third diminishing portion and the surface of the tread block part, including a portion of which the width is maintained constant.
